(19) United States
(12) Patent Application Publication
(10) Pub. No.: US 2005/0183122 A1
(43) Pub. Date: Aug. 18, 2005

(54) System to reorganize how television channels are displayed

(76) Inventor: Paul William Bayon, Redding, CA (US)

Correspondence Address: Paul W. Bayon, 20780 Old 44 Drive, Redding, CA, 96003, US

(21) Appl. No.: 10/781,415

(22) Filed: Feb. 17, 2004

(51) Int. Cl. H04N 5/445; G06F 3/00; G06F 13/00

(52) U.S. Cl. 725/47; 725/44; 725/39

(57) ABSTRACT

A system allowing a user or users to reprogram the channel sequence received from the provider in their own desired order showing only the channels they want in order to have a more efficient use or viewing experience

### CROSS REFERENCE TO RELATED APPLICATION

Not Applicable

### FEDERALLY SPONSORED RESEARCH

Not Applicable

### SEQUENCE LISTING OR PROGRAN

Not Applicable

### BACKGROUND OF THE INVENTION

1. Field of Invention

This invention relates to how television channels are displayed to the viewer

2. Background of the Invention

It is presently difficult and cumbersome when viewing or recording existing television programs given the large multitude of channels that are provided. Current TV, VCR, Satellite Receiving Systems and other electronic devices allow the user to receive a large variety of channels. They only allow the user (or users) to view the channels by inputting specific channel numbers or using the up and down buttons to move incrementally in the order as received by the provider. These system can block out channels such that a channel is skipped when flipping through the system or a user (or users) can set up a favorite lists accessible on another screen to bring a limited ease of use when dealing with the multitude of channels when watching or recording Television. These functions are still very limiting.

### OBJECTS AND ADVANTAGES

This invention relates to improving the functionality of television channels such that the user has more control and choices. This method will allow the user to overlay the channel sequence as received by the provider with a new set and order of what will be called display channels. The system would treat the channels in two distinct ways. A Television or other related device picks up specific wavelengths and signals to provide each individual channel in its normal course of operating. The system would receive the channels from the provider in the present manner, which will be called “receiving.” The system will show the channels in an alternate way, which will be called “displaying.” The user will be enabled to organize the channels in any order that the user may choose. Thus when the user flips through the channels they will show up in the order of displaying instead of “receiving”. This new method either built as an independent box or into a system (such as television, VCR, Satellite System or other electronic device) would change the order how each receiving signal is displayed. This would allow the user to visually program the order in which each channel is shown so that the user can put the channels in the users desired order.

### SUMMARY

A system allowing a user or users to reprogram the channel sequence received from the provider in order to have a more efficient use or viewing experience

### DETAILED DESCRIPTION

As an Example if the current channels provided to the user were as follows the user could reorder the display sequence:

| | | |
|---|---|---|
| Signal Comes in as | | Desire to Reprogram as |
| “Receiving” | Station Name | “Displaying” |

Before Programming

| | | |
|---|---|---|
| 2 | Local CBS | 11 |
| 3 | Local NBC | 12 |
| 4 | Local ABC | 13 |
| 5 | Local FOX | 14 |
| 6 | Local UPN | 15 |
| 7 | Local PBS | 16 |
| 8 | TBS | 2 |
| 9 | TNT | 3 |
| 10 | USA | 4 |
| 11 | SCIFI | blocked |
| 12 | Lifetime | blocked |
| 13 | ESPN | 5 |
| 14 | Home Shopping | blocked |
| 15 | C-Span | 6 |
| 16 | CNN | 8 |
| 17 | Fox News | 7 |
| 18 | Soap | blocked |
| 19 | Food | 9 |
| 20 | Home & Garden | 10 |

After Programming

| | | |
|---|---|---|
| 8 | TBS | 2 |
| 9 | TNT | 3 |
| 10 | USA | 4 |
| 13 | ESPN | 5 |
| 15 | C-Span | 6 |
| 17 | Fox News | 7 |
| 16 | CNN | 8 |
| 19 | Food | 9 |
| 20 | Home & Garden | 10 |
| 2 | Local CBS | 11 |
| 3 | Local NBC | 12 |
| 4 | Local ABC | 13 |
| 5 | Local FOX | 14 |
| 6 | Local UPN | 15 |
| 7 | Local PBS | 16 |
| 11 | SCIFI | Blocked 17 |
| 12 | Lifetime | Blocked 18 |
| 14 | Home Shopping | Blocked 19 |
| 18 | Soap | Blocked 20 |

The user can put the channels in the users desired order. When pushing the up button for channels the device would know to bounce from receiving channels 8 to 9 to 10 and then to 13 to 15 to 17 to 16 when the television would show the user it was going from 2 to 3 to 4 to 5 to 6 to 7 and to 8. Multiple users would be allowed to set up their own user identification and desired sequence and viewing options. When a user turns on the Television the user puts in his or her identification and the system uses their personal set up information. Any blocked channels would fall to the end of the line within the sequence order.

This would make channel surfing for every user easier and more effective. Whereas the user is able to discard unwanted channels from normal channel surfing. The user would also be able to put the wanted channels in their own desired order such that if a user wanted all the news channels together than they can keep the news channels together or the user can put all the movie channels together. If the user only normally like watching a limited number of stations then they can keep all the unwanted stations from being in the way. The user would always be able to switch back to the standard channel order but this provides more options for each viewer and more functionality for each viewer. It is also important that multiple users can set up their own display order so that each person can have their own setup for ease of use.

1) A system that receives in the television channels but allows the user to reassign the order in which the channels are displayed into their own personally desired sequence.

2) The system of claim 1 would also allow programming for multiple users, through use of a user identification code for each user, to set up their own alternative display order.
